(19) United States
(12) Patent Application Publication
(10) Pub. No.: US 2017/0113908 A1
(43) Pub. Date: Apr. 27, 2017

(54) SMART JACK FOR LIFTING

(71) Applicant: Intel Corporation, Santa Clara, CA (US)

(72) Inventors: Stephen Chadwick, Chandler, AZ (US); Michael Moran, Naas (IE); Casey Baron, Chandler, AZ (US); Tobias Kohlenberg, Portland, OR (US)

(21) Appl. No.: 14/922,913

(22) Filed: Oct. 26, 2015

(51) Int. Cl. B66F 17/00

(52) U.S. Cl. CPC B66F 17/00

(57) ABSTRACT

Various systems and methods for using a smart jack are described herein. A smart jack device may comprises a lifting mechanism; at least one of: a position sensor or a motion sensor; a processor subsystem; and a memory including instructions, which when executed by the processor subsystem, cause the processor subsystem to: access sensor data from at least one of: the position sensor or the motion sensor, the sensor data indicative of a state of the smart jack device; and cause the presentation of an indication of the state of the smart jack device.

### TECHNICAL FIELD

Embodiments described herein generally relate to lifting mechanisms and in particular, to a smart jack for lifting.

### BACKGROUND

A jack is a device for lifting heavy objects, such as a vehicle. Jacks come in various forms, including scissor jacks, screw jacks, hydraulic jacks, farm jacks, and pneumatic jacks. Improper use of a jack may result in vehicle damage or personal injury.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a diagram illustrating a smart jack, according to an embodiment;

FIG. 3 is a diagram illustrating a display, according to an embodiment;

FIG. 4 is a diagram illustrating a display, according to an embodiment;

FIG. 5 is a block diagram illustrating a smart jack device, according to an embodiment;

FIG. 6 is a block diagram illustrating a smart jack device, according to an embodiment;

FIG. 7 is a flowchart illustrating a method of using a smart jack, according to an embodiment; and

FIG. 8 is a block diagram illustrating an example machine upon which any one or more of the techniques (e.g., methodologies) discussed herein may perform, according to an example embodiment.

### DETAILED DESCRIPTION

Systems and methods described herein provide a smart jack for lifting objects, such as vehicles. In general, the number of personal injuries that are a result of improper jack placement or use is significant. Cars and trucks collapse and kill people in situations where the jack is used incorrectly. Using electronics and sensors, the smart jack described herein provides additional safety features not found in conventional jacks.

The smart jack includes sensors to determine various safety features, including whether the jack is on level ground, whether the jack is placed correctly with respect to the object being lifted (e.g., a vehicle), whether the environmental conditions (e.g., the ground) are sound, and the like. The smart jack may communicate with one or more devices, such as the vehicle or a mobile user device, to provide an informational user interface. The detailed feedback that the smart jack provides increases the safe use of the jack.

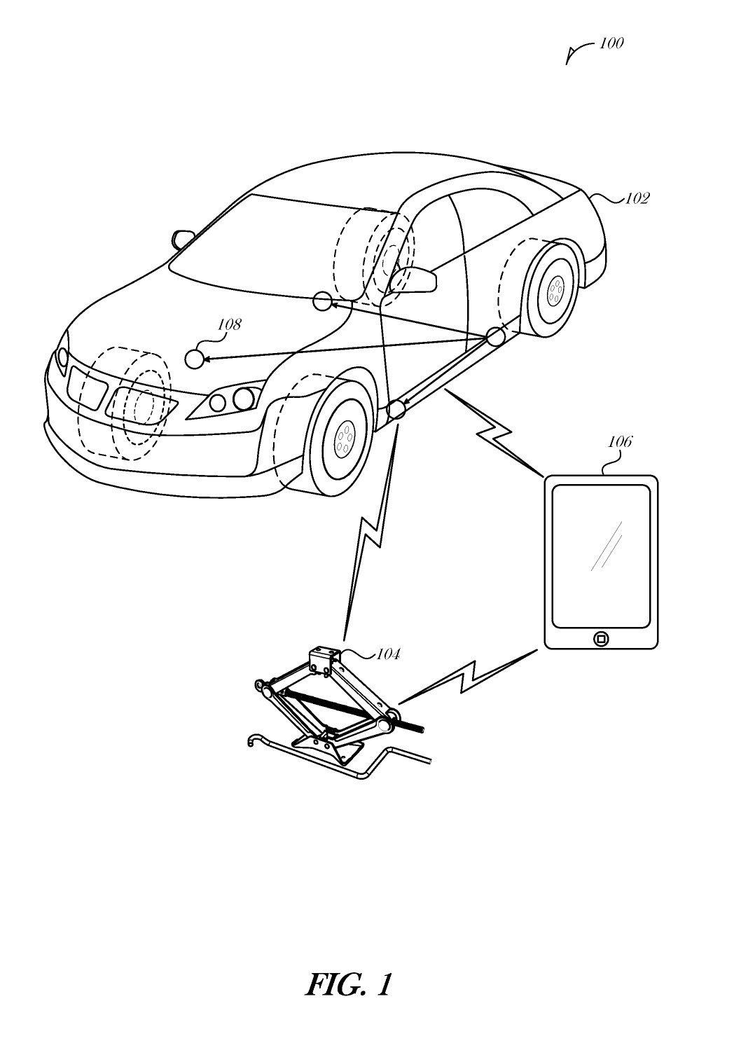

FIG. 1 is a diagram illustrating an operating environment 100, according to an embodiment. The operating environment 100 includes a vehicle 102 and a smart jack 104. The operating environment 100 may optionally include a user device 106. The vehicle 102 may include one or more sensors 108. The sensors 108 may include an accelerometer, a gyroscope, a location positioning system (e.g., global positioning system, GLONASS, or the like), radio-frequency identification (RFID) receivers, Bluetooth receivers, or the like. The smart jack 104 may include similar sensor as the sensors 108 found in the vehicle 102. The smart jack 104 may also include a weight sensor or ground surface sensor. The smart jack 104 may also include one or more Bluetooth transmitters or RFID tags. In addition, the smart jack 104 may include one or more displays or other visual presentation mechanisms.

The user device 106 may be may be any type of compute device including, but not limited to a mobile phone, a smartphone, a phablet, a tablet, a personal digital assistant, a laptop, a digital camera, a desktop computer, an in-vehicle infotainment system, or the like.

In use, the smart jack 104 may be positioned under the vehicle 102. As an example use case, the jack placement under a car is easily compromised when placed on uneven ground. Sensors within the smart jack 104 and/or the vehicle 102 may detect movement and alert the user of these conditions. Use of accelerometers and/or gyroscopes within the smart jack 104 may detect vertical, horizontal, or rotational movement indicating that the smart jack 104 is sinking, shifting, sliding, or losing stability. Similar motion sensors within the vehicle 102 may be used separately or in combination with those in the smart jack 104 to detect movement of the vehicle 102. The movement of the vehicle 102 may be a result of the ground giving away, the smart jack 104 failing, people moving in the car, people pushing on the car from the outside, or other causes. A user interface on either the smart jack 104 or in the vehicle 102 may be used to alert the user of a dangerous situation. For example, the in-vehicle infotainment system may flash a warning screen and the vehicle 102 may begin honking.

As another example use case, failure to position the smart jack 104 correctly under the object it is intended to lift is dangerous and may result in personal injury or property damage. Using sensors in the smart jack 104 and/or the vehicle 102, the user may be informed of the correct placement. The smart jack 104 may communicate with the sensors 108 in the vehicle 102. For example, a Bluetooth beacon array may be arranged in the vehicle 102 and be used to detect a Bluetooth transmitter on the smart jack 104. Using received signal strength indicators, the Bluetooth beacon array may determine the position of the smart jack 104 with relation to portions of the vehicle 102. A user interface on either the smart jack 104 or in the vehicle 102 or in another device (e.g., user device 106), may provide information to the user on the correct placement of the jack.

The smart jack 104 may include a communication mechanism to communicate with the vehicle 102. The communication mechanism may communicate via wireless communications channels or direct connection (e.g., where the device docks, or connects, with a USB port or similar interface of the vehicle 102). For example, the communication mechanism may include a wireless communication radio, such as cellular, Bluetooth, or a near-field communication (NFC) connection. Alternatively, the communication mechanism may use a direct connection mode, such as by linking into the on-board vehicle system using ODB-II, for example. Using wired or wireless connections, the smart jack 104 may connect to the vehicle's 102 controller area network (CAN) bus. The sensors 108 may be incorporated into the vehicle's 102 CAN bus or independent from it.

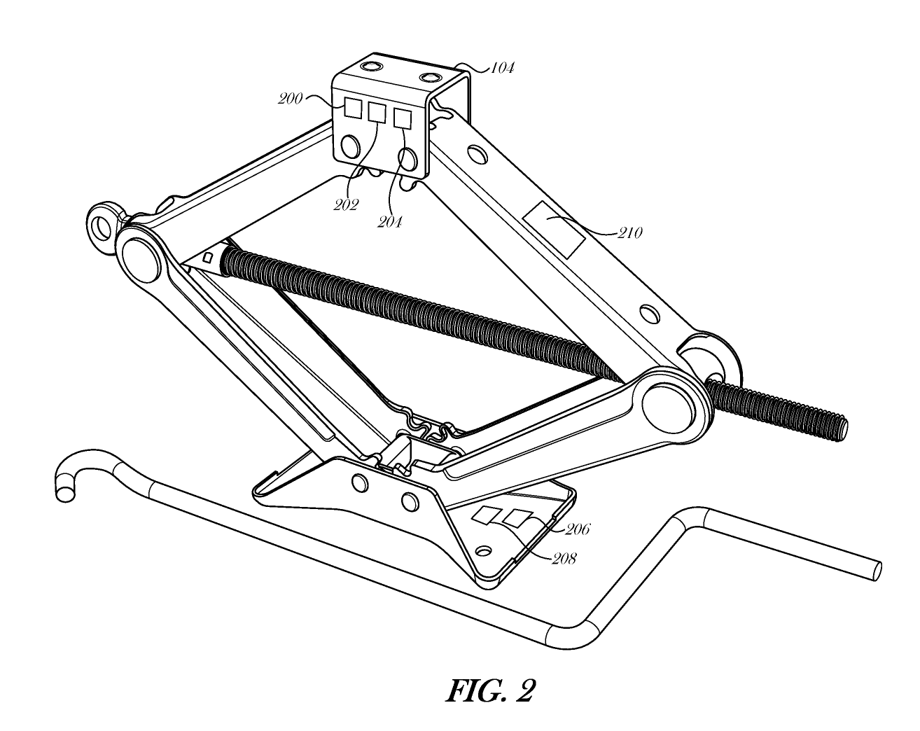

FIG. 2 is a diagram illustrating a smart jack 104, according to an embodiment. Although the smart jack 104 illustrated in FIG. 2 is a scissors jack, commonly found in automotive contexts, it is understood that the smart jack 104 may be any type of jack design including, but not limited to scissor jacks, screw jacks, hydraulic jacks, farm jacks, and pneumatic jacks. The smart jack 104 includes an accelerometer 200, a gyroscope 202, a weight sensor 204, and a ground surface sensor 206. The smart jack 104 also includes a communication module 208. The communication module 208 may be configured to connect to one or more types of communication networks including, but not limited to cellular networks, Wi-Fi networks, Bluetooth networks, personal area networks, near-field communication networks, or the like. The communication module 208 may communicate with the object being lifted (e.g., the vehicle 102 from FIG. 1). The sensors 200, 202, 204, and 206 along with the communication module 208 may be integrated into a system on chip (SoC) integrated circuit.

The accelerometer 200 may be used to detect linear acceleration or movement. Multiple accelerometers may be used in the smart jack 104. The accelerometer 200 may be used to detect whether the smart jack 104 is sinking or shifting.

The gyroscope 202 may be used to detect rotational movement. The gyroscope 202 may detect whether the smart jack 104 is twisting under load, which may cause instability and jack failure.

The weight sensor 204 may be used to detect the amount of downward force being applied to the smart jack 104. Based on a preset threshold weight, the weight sensor 204 may be used to determine when too much weight is on the smart jack 104 and whether the smart jack 104 is subject to component failure.

The ground surface sensor 206 may be used to detect the condition of the ground, such as whether the ground is soggy or unsteady. Ground conditions may be determined by interpreting sensor data from other sensors, such as the accelerometer 200 (e.g., to detect sinking). The ground surface sensor 206 may include a moisture sensor to detect an amount of moisture in the ground surface in contact with the smart jack 104. A higher amount of moisture may be indicative of a less sturdy surface.

The smart jack 104 may also include one or more displays 210 or other visual output mechanisms (e.g., an array of light-emitting diodes (LEDs)). The displays 210 may be used to warn the user of the smart jack 104 of potential danger or failure of the smart jack 104. The displays 210 may also be used to initially place the smart jack 104 under the object being lifted.

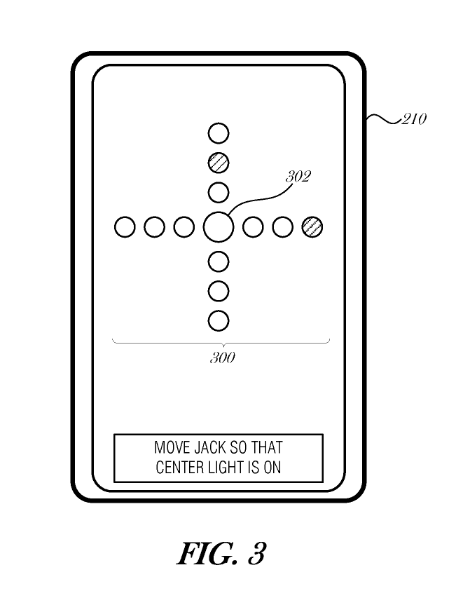

FIG. 3 is a diagram illustrating a display 210, according to an embodiment. The display 210 includes a plurality of LEDs 300 in a crosshairs arrangement. The LEDs 300 may be illuminated in two colors: green and red, for example. As the user moves the smart jack 104 around under the vehicle 102, the LEDs 300 may change color to indicate the smart jack's 104 location relative to a correct or preferred jack point under the vehicle 102. When the user positions the smart jack 104 in the correct place, the center light 302 may be illuminated. It is understood that the color arrangement described here is merely for example and that any number of colors may be used.

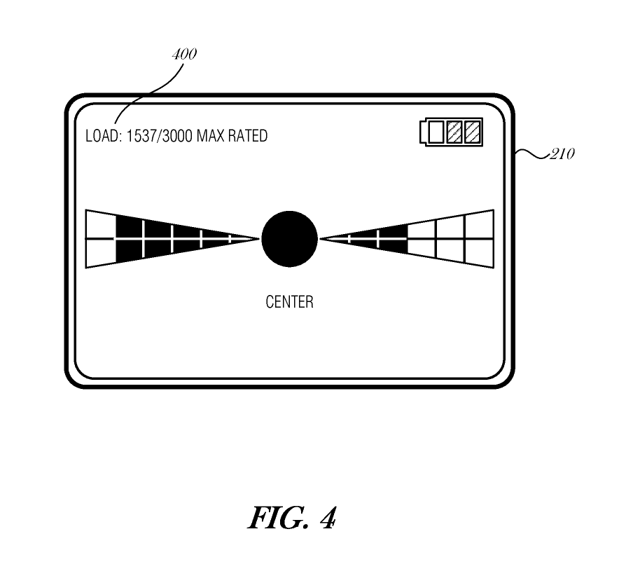

FIG. 4 is a diagram illustrating a display 210, according to an embodiment. The display 210 in FIG. 4 is a liquid crystal display (LCD). It is understood that any type of display mechanism may be used including, but not limited to LCD, LED, organic LED, plasma display, electronic ink, and the like. The display 210 includes indicia used to center the smart jack 104 under a jack point in the vehicle 102. The display 210 includes a load reading 400 indicating current load and max load in pounds. It is understood that the weight may be measured and presented in any unit, such as pounds, tons, or kilograms.

FIG. 5 is a block diagram illustrating a smart jack device 500, according to an embodiment. The smart jack device 500 may include a lifting mechanism 502, a position sensor 504, a motion sensor 506, a sensor control module 508, and a presentation module 510. While both a position sensor 504 and a motion sensor 506 are illustrated in FIG. 5, it is understood that the smart jack device 500 may have one type of sensor and not the other.

The lifting mechanism 502 may be any type of mechanism, as discussed above, which may include scissors jacks, screw jacks, and the like. In an embodiment, the lifting mechanism 502 is a scissors jack. In an embodiment, the lifting mechanism 502 comprises a hydraulic jack. In an embodiment, the lifting mechanism 502 comprises a pneumatic jack.

The position sensor 504 may be any type of device capable of determining the smart jack device 500 position either in absolute terms (e.g., latitude and longitude) or relative terms (e.g., position in relation to one or more fixed points in a vehicle). In an embodiment, the position sensor 504 comprises a global positioning system receiver. In an embodiment, the position sensor 504 comprises a short-range telemetry circuit. The short-range telemetry circuit comprises an RFID location system. In such an embodiment, the smart jack device 500 may have a RFID tag and a vehicle may have one or more RFID beacons to detect the position of the smart jack device 500 with respect to the vehicle. In a similar manner, the smart jack device 500 may have a Bluetooth transmitter and the vehicle may have one or more Bluetooth receivers to determine relative position. As such, in an embodiment, the short-range telemetry circuit comprises a Bluetooth location system.

The motion sensor 506 may be any type of device capable of detecting motion of the smart jack device 500 or the object being lifted, such as a vehicle. In an embodiment, the motion sensor 506 comprises an accelerometer. In an embodiment, the motion sensor 506 comprises a gyroscope.

The sensor control module 508 may be configured to access sensor data from at least one of: the position sensor 504 or the motion sensor 506, the sensor data indicative of a state of the smart jack device 500. The state of the smart jack device 500 may be the jack's position, alignment, movement, load, battery charge, or other information of how the smart jack device 500 is operating or about forces acting on the smart jack device 500.

In an embodiment, the state of the smart jack device 500 comprises a movement in the vertical or horizontal plane. For example, the smart jack device 500 may move as a unit vertically when sinking into wet soil, or portions of the smart jack device 500 may move vertically, such as when the extending arm fails and begins to collapse. In such an embodiment, the presentation module 510 is to sound an alarm. The alarm may be a siren, beep, or other audible alarm. The alarm may include flashing lights or other displayed notifications. In an embodiment, the alarm is produced at the smart jack device 500 using speakers, displays, or other output mechanisms. In another embodiment, the alarm is produced at an object being lifted by the smart jack device 500, such as within a vehicle using the in-dash system.

The presentation module 510 may be configured to cause the presentation of an indication of the state of the smart jack device 500.

In an embodiment, the presentation module 510 is to present an alignment user interface on a display to indicate a position of the smart jack device with respect to an object the smart jack device 500 is to lift. The display may be incorporated into the smart jack device 500, on a user device (e.g., a smartphone), or in an onboard infotainment system. In an embodiment, the object the 500 is to lift comprises a vehicle. In an embodiment, the alignment user interface comprises a crosshair configuration of light-emitting diodes. In an embodiment, the alignment user interface comprises a level indicator in at least one of: the horizontal plane or the vertical plane. Such user interfaces are illustrated above in FIGS. 3-4.

In an embodiment, the alignment user interface comprises a representation of the object the smart jack device is to lift and a representation of the smart jack device with respect to the representation of the object. In a further embodiment, the object comprises a vehicle. Thus, a user interface may illustrate a shape in the form of the user's vehicle with additional icons to illustrate jack points and the smart jack device 500 position. The representation of the object may be personalized or customized. For example, the vehicle being shown in the user interface may be similar to the one being lifted. Use of a personalized or customized interface may decrease the possibilities of an accident or equipment failure.

In an embodiment, the presentation module 510 is to transmit information to an in-vehicle infotainment system for displaying the indication of the state of the smart jack device. A display on a smart jack device 500 may be relatively small, so using a larger display in a vehicle may be easier to reference for a user.

In an embodiment, the presentation module is to transmit information to a user device for displaying the indication of the state of the smart jack device. In such an embodiment, the user device may be any type of mobile device, such as a smartphone, phablet, tablet computer, laptop computer, wearable device (e.g., smartglasses, smartwatch, or the like), etc.

In various embodiments, the indication of the state comprises at least one of: a load indication, an alignment indication, or a positioning indication.

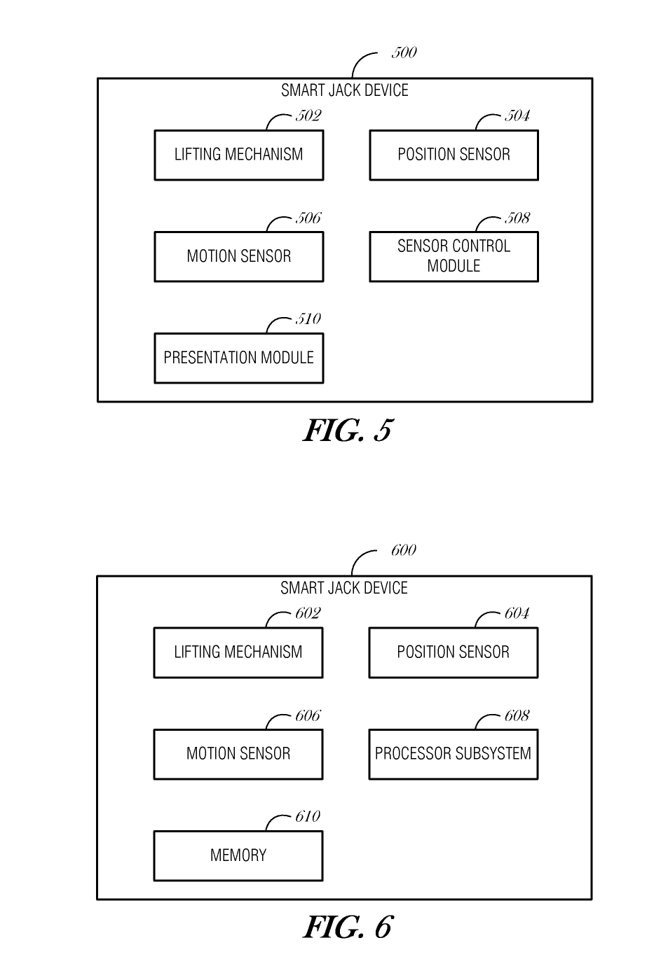

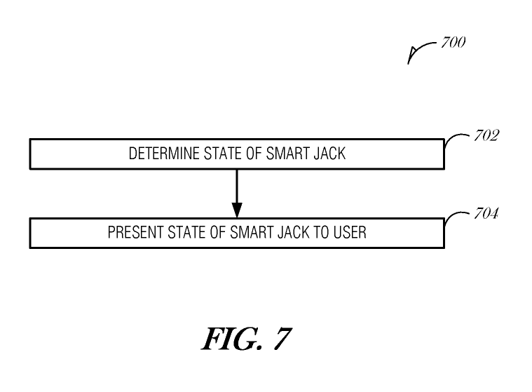

FIG. 6 is a block diagram illustrating a smart jack device 600, according to an embodiment. The smart jack device 600 includes a lifting mechanism 602, a position sensor 604, a motion sensor 606, a processor subsystem 608, and a memory 610. The memory 610 may include instructions, which when executed on the processor subsystem 608, cause the processor subsystem 608 to perform operations. The processor subsystem 608 may include one or more processors with one or more cores on each of the one or more processors. The lifting mechanism 602, position sensor 604, and motion sensor 606 may be components as described above with respect to FIG. 5. Thus, in various embodiments, the lifting mechanism 602 may be a scissors jack, a hydraulic jack, or a pneumatic jack. Also, the position sensor 604 may be a global positioning system receiver or a short-range telemetry circuit, in various embodiments. In a further embodiment, the short-range telemetry circuit comprises an RFID location system. In another embodiment, the short-range telemetry circuit comprises a Bluetooth location system. Also, the motion sensor 606 may be an accelerometer or a gyroscope.

The processor subsystem 608 may access sensor data from at least one of: the position sensor 604 or the motion sensor 606, the sensor data indicative of a state of the smart jack device 600 and cause the presentation of an indication of the state of the smart jack device 600.

In an embodiment, the state of the smart jack device 600 comprises a movement in the vertical or horizontal plane, and the instructions to cause the presentation of the indication of the state of the smart jack device, comprise instructions to sound an alarm. In an embodiment, the alarm is produced at the smart jack device 600. In an embodiment, the alarm is produced at an object being lifted by the smart jack device 600.

In an embodiment, the instructions to cause the presentation of the indication of the state of the smart jack device, comprise instructions to present an alignment user interface on a display to indicate a position of the smart jack device 600 with respect to an object the smart jack device 600 is to lift. In a further embodiment, the object comprises a vehicle.

In an embodiment, the alignment user interface comprises a crosshair configuration of light-emitting diodes. In an embodiment, the alignment user interface comprises a level indicator in at least one of: the horizontal plane or the vertical plane. In an embodiment, the alignment user interface comprises a representation of the object the smart jack device is to lift and a representation of the smart jack device 600 with respect to the representation of the object. In a further embodiment, the object comprises a vehicle.

In an embodiment, the instructions to cause the presentation of the indication of the state of the smart jack device 600, comprise instructions to transmit information to an in-vehicle infotainment system for displaying the indication of the state of the smart jack device 600.

In an embodiment, the instructions to cause the presentation of the indication of the state of the smart jack device 600, comprise instructions to transmit information to a user device for displaying the indication of the state of the smart jack device 600.

In various embodiments, the indication of the state comprises at least one of: a load indication, an alignment indication, or a positioning indication.

FIG. 7 is a flowchart illustrating a method 700 of using a smart jack, according to an embodiment. At block 702, at a smart jack, a state of the smart jack based on sensor data is determined. In an embodiment, the sensor data comprises data from a global positioning system receiver. In an embodiment, the sensor data comprises data from a short-range telemetry circuit. In a further embodiment, the short-range telemetry circuit comprises an RFID location system. In another embodiment, the short-range telemetry circuit comprises a Bluetooth location system.

In an embodiment, the sensor data comprises data from a motion sensor. In a further embodiment, the motion sensor comprises an accelerometer. In another embodiment, the motion sensor comprises a gyroscope.

In an embodiment, the smart jack comprises a scissors jack. In an embodiment, the smart jack comprises a hydraulic jack. In an embodiment, the smart jack comprises a pneumatic jack.

At block 704, an indication of the state of the smart jack is presented to a user.

In an embodiment, determining the state of the smart jack based on sensor data comprises detecting a movement of the smart jack in the vertical or horizontal plane, and wherein presenting the indication of the state of the smart jack device to the user comprises sounding an alarm. In a further embodiment, sounding the alarm comprises producing the alarm at the smart jack device. In another embodiment, sounding the alarm comprises causing the alarm to be sounded from an object being lifted by the smart jack device.

In an embodiment, presenting the indication of the state of the smart jack device to the user comprises presenting an alignment user interface to indicate a position of the smart jack device with respect to an object the smart jack device is to lift. In a further embodiment, the object comprises a vehicle.

In an embodiment, the alignment user interface comprises a crosshair configuration of light-emitting diodes. In an embodiment, the alignment user interface comprises a level indicator in at least one of: the horizontal plane or the vertical plane. In an embodiment, the alignment user interface comprises a representation of the object the smart jack device is to lift and a representation of the smart jack device with respect to the representation of the object. In a further embodiment, the object comprises a vehicle.

In an embodiment, presenting the indication of the state of the smart jack device to the user comprises transmitting information to an in-vehicle infotainment system for displaying the indication of the state of the smart jack device.

In an embodiment, presenting the indication of the state of the smart jack device to the user comprises transmitting information to a user device for displaying the indication of the state of the smart jack device.

In embodiments, the indication of the state comprises at least one of: a load indication, an alignment indication, or a positioning indication.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

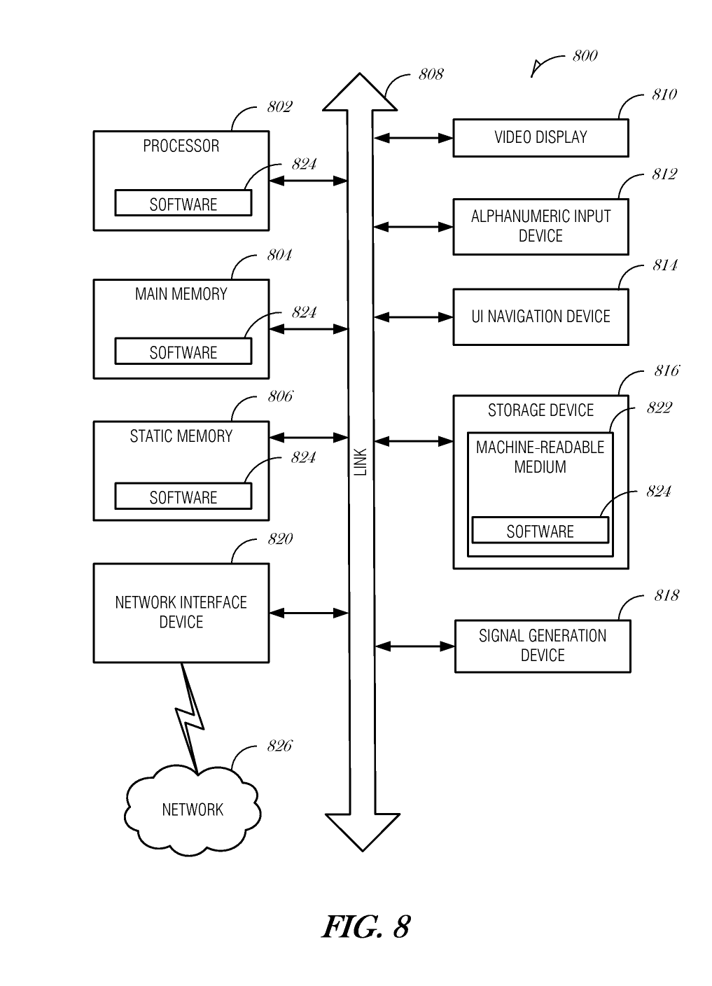

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter for a smart jack device (such as a device, apparatus, or machine) comprising: a lifting mechanism; at least one of: a position sensor or a motion sensor; a processor subsystem; and a memory including instructions, which when executed by the processor subsystem, cause the processor subsystem to: access sensor data from at least one of: the position sensor or the motion sensor, the sensor data indicative of a state of the smart jack device; and cause the presentation of an indication of the state of the smart jack device.

In Example 2, the subject matter of Example 1 may include, wherein the lifting mechanism comprises a scissors jack.

In Example 3, the subject matter of any one of Examples 1 to 2 may include, wherein the lifting mechanism comprises a hydraulic jack.

In Example 4, the subject matter of any one of Examples 1 to 3 may include, wherein the lifting mechanism comprises a pneumatic jack.

In Example 5, the subject matter of any one of Examples 1 to 4 may include, wherein the position sensor comprises a global positioning system receiver.

In Example 6, the subject matter of any one of Examples 1 to 5 may include, wherein the position sensor comprises a short-range telemetry circuit.

In Example 7, the subject matter of any one of Examples 1 to 6 may include, wherein the short-range telemetry circuit comprises an RFID location system.

In Example 8, the subject matter of any one of Examples 1 to 7 may include, wherein the short-range telemetry circuit comprises a Bluetooth location system.

In Example 9, the subject matter of any one of Examples 1 to 8 may include, wherein the motion sensor comprises an accelerometer.

In Example 10, the subject matter of any one of Examples 1 to 9 may include, wherein the motion sensor comprises a gyroscope.

In Example 11, the subject matter of any one of Examples 1 to 10 may include, wherein the state of the smart jack device comprises a movement in the vertical or horizontal plane, and wherein instructions to cause the presentation of the indication of the state of the smart jack device, comprise instructions to: sound an alarm.

In Example 12, the subject matter of any one of Examples 1 to 11 may include, wherein the alarm is produced at the smart jack device.

In Example 13, the subject matter of any one of Examples 1 to 12 may include, wherein the alarm is produced at an object being lifted by the smart jack device.

In Example 14, the subject matter of any one of Examples 1 to 13 may include, wherein the instructions to cause the presentation of the indication of the state of the smart jack device, comprise instructions to: present an alignment user interface on a display to indicate a position of the smart jack device with respect to an object the smart jack device is to lift.

In Example 15, the subject matter of any one of Examples 1 to 14 may include, wherein the object comprises a vehicle.

In Example 16, the subject matter of any one of Examples 1 to 15 may include, wherein the alignment user interface comprises a crosshair configuration of light-emitting diodes.

In Example 17, the subject matter of any one of Examples 1 to 16 may include, wherein the alignment user interface comprises a level indicator in at least one of: the horizontal plane or the vertical plane.

In Example 18, the subject matter of any one of Examples 1 to 17 may include, wherein the alignment user interface comprises a representation of the object the smart jack device is to lift and a representation of the smart jack device with respect to the representation of the object.

In Example 19, the subject matter of any one of Examples 1 to 18 may include, wherein the object comprises a vehicle.

In Example 20, the subject matter of any one of Examples 1 to 19 may include, wherein the instructions to cause the presentation of the indication of the state of the smart jack device, comprise instructions to: transmit information to an in-vehicle infotainment system for displaying the indication of the state of the smart jack device.

In Example 21, the subject matter of any one of Examples 1 to 20 may include, wherein the instructions to cause the presentation of the indication of the state of the smart jack device, comprise instructions to: transmit information to a user device for displaying the indication of the state of the smart jack device.

In Example 22, the subject matter of any one of Examples 1 to 21 may include, wherein the indication of the state comprises at least one of: a load indication, an alignment indication, or a positioning indication.

Example 23 includes subject matter for a smart jack device (such as a device, apparatus, or machine) comprising: a lifting mechanism; at least one of: a position sensor or a motion sensor; a sensor control module to access sensor data from at least one of: the position sensor or the motion sensor, the sensor data indicative of a state of the smart jack device; and a presentation module to cause the presentation of an indication of the state of the smart jack device.

In Example 24, the subject matter of Example 23 may include, wherein the lifting mechanism comprises a scissors jack.

In Example 25, the subject matter of any one of Examples 23 to 24 may include, wherein the lifting mechanism comprises a hydraulic jack.

In Example 26, the subject matter of any one of Examples 23 to 25 may include, wherein the lifting mechanism comprises a pneumatic jack.

In Example 27, the subject matter of any one of Examples 23 to 26 may include, wherein the position sensor comprises a global positioning system receiver.

In Example 28, the subject matter of any one of Examples 23 to 27 may include, wherein the position sensor comprises a short-range telemetry circuit.

In Example 29, the subject matter of any one of Examples 23 to 28 may include, wherein the short-range telemetry circuit comprises an RFID location system.

In Example 30, the subject matter of any one of Examples 23 to 29 may include, wherein the short-range telemetry circuit comprises a Bluetooth location system.

In Example 31, the subject matter of any one of Examples 23 to 30 may include, wherein the motion sensor comprises an accelerometer.

In Example 32, the subject matter of any one of Examples 23 to 31 may include, wherein the motion sensor comprises a gyroscope.

In Example 33, the subject matter of any one of Examples 23 to 32 may include, wherein the state of the smart jack device comprises a movement in the vertical or horizontal plane, and wherein the presentation module is to sound an alarm.

In Example 34, the subject matter of any one of Examples 23 to 33 may include, wherein the alarm is produced at the smart jack device.

In Example 35, the subject matter of any one of Examples 23 to 34 may include, wherein the alarm is produced at an object being lifted by the smart jack device.

In Example 36, the subject matter of any one of Examples 23 to 35 may include, wherein the presentation module is to: present an alignment user interface on a display to indicate a position of the smart jack device with respect to an object the smart jack device is to lift.

In Example 37, the subject matter of any one of Examples 23 to 36 may include, wherein the object comprises a vehicle.

In Example 38, the subject matter of any one of Examples 23 to 37 may include, wherein the alignment user interface comprises a crosshair configuration of light-emitting diodes.

In Example 39, the subject matter of any one of Examples 23 to 38 may include, wherein the alignment user interface comprises a level indicator in at least one of: the horizontal plane or the vertical plane.

In Example 40, the subject matter of any one of Examples 23 to 39 may include, wherein the alignment user interface comprises a representation of the object the smart jack device is to lift and a representation of the smart jack device with respect to the representation of the object.

In Example 41, the subject matter of any one of Examples 23 to 40 may include, wherein the object comprises a vehicle.

In Example 42, the subject matter of any one of Examples 23 to 41 may include, wherein the presentation module is to: transmit information to an in-vehicle infotainment system for displaying the indication of the state of the smart jack device.

In Example 43, the subject matter of any one of Examples 23 to 42 may include, wherein the presentation module is to: transmit information to a user device for displaying the indication of the state of the smart jack device.

In Example 44, the subject matter of any one of Examples 23 to 43 may include, wherein the indication of the state comprises at least one of: a load indication, an alignment indication, or a positioning indication.

Example 45 includes subject matter for using a smart jack (such as a method, means for performing acts, machine readable medium including instructions that when performed by a machine cause the machine to performs acts, or an apparatus to perform) comprising: determining, by the smart jack, a state of the smart jack based on sensor data; and presenting an indication of the state of the smart jack to a user.

In Example 46, the subject matter of Example 45 may include, wherein the smart jack comprises a scissors jack.

In Example 47, the subject matter of any one of Examples 45 to 46 may include, wherein the smart jack comprises a hydraulic jack.

In Example 48, the subject matter of any one of Examples 45 to 47 may include, wherein the smart jack comprises a pneumatic jack.

In Example 49, the subject matter of any one of Examples 45 to 48 may include, wherein the sensor data comprises data from a global positioning system receiver.

In Example 50, the subject matter of any one of Examples 45 to 49 may include, wherein the sensor data comprises data from a short-range telemetry circuit.

In Example 51, the subject matter of any one of Examples 45 to 50 may include, wherein the short-range telemetry circuit comprises an RFID location system.

In Example 52, the subject matter of any one of Examples 45 to 51 may include, wherein the short-range telemetry circuit comprises a Bluetooth location system.

In Example 53, the subject matter of any one of Examples 45 to 52 may include, wherein the sensor data comprises data from a motion sensor.

In Example 54, the subject matter of any one of Examples 45 to 53 may include, wherein the motion sensor comprises an accelerometer.

In Example 55, the subject matter of any one of Examples 45 to 54 may include, wherein the motion sensor comprises a gyroscope.

In Example 56, the subject matter of any one of Examples 45 to 55 may include, wherein determining the state of the smart jack based on sensor data comprises detecting a movement of the smart jack in the vertical or horizontal plane, and wherein presenting the indication of the state of the smart jack to the user comprises sounding an alarm.

In Example 57, the subject matter of any one of Examples 45 to 56 may include, wherein sounding the alarm comprises producing the alarm at the smart jack.

In Example 58, the subject matter of any one of Examples 45 to 57 may include, wherein sounding the alarm comprises causing the alarm to be sounded from an object being lifted by the smart jack.

In Example 59, the subject matter of any one of Examples 45 to 58 may include, wherein presenting the indication of the state of the smart jack to the user comprises: presenting an alignment user interface to indicate a position of the smart jack with respect to an object the smart jack is to lift.

In Example 60, the subject matter of any one of Examples 45 to 59 may include, wherein the object comprises a vehicle.

In Example 61, the subject matter of any one of Examples 45 to 60 may include, wherein the alignment user interface comprises a crosshair configuration of light-emitting diodes.

In Example 62, the subject matter of any one of Examples 45 to 61 may include, wherein the alignment user interface comprises a level indicator in at least one of: the horizontal plane or the vertical plane.

In Example 63, the subject matter of any one of Examples 45 to 62 may include, wherein the alignment user interface comprises a representation of the object the smart jack is to lift and a representation of the smart jack with respect to the representation of the object.

In Example 64, the subject matter of any one of Examples 45 to 63 may include, wherein the object comprises a vehicle.

In Example 65, the subject matter of any one of Examples 45 to 64 may include, wherein presenting the indication of the state of the smart jack to the user comprises: transmitting information to an in-vehicle infotainment system for displaying the indication of the state of the smart jack.

In Example 66, the subject matter of any one of Examples 45 to 65 may include, wherein presenting the indication of the state of the smart jack to the user comprises: transmitting information to a user device for displaying the indication of the state of the smart jack.

In Example 67, the subject matter of any one of Examples 45 to 66 may include, wherein the indication of the state comprises at least one of: a load indication, an alignment indication, or a positioning indication.

Example 68 includes at least one machine-readable medium including instructions, which when executed by a machine, cause the machine to perform operations of any of the Examples 45-67.

Example 69 includes an apparatus comprising means for performing any of the Examples 45-67.

Example 70 includes subject matter for a smart jack apparatus (such as a device, apparatus, or machine) comprising: a lifting mechanism; means for determining a state of the smart jack apparatus based on sensor data; and means for presenting an indication of the state of the smart jack apparatus to a user.

In Example 71, the subject matter of Example 70 may include, wherein the lifting mechanism comprises a scissors jack.

In Example 72, the subject matter of any one of Examples 70 to 71 may include, wherein the lifting mechanism comprises a hydraulic jack.

In Example 73, the subject matter of any one of Examples 70 to 72 may include, wherein the lifting mechanism comprises a pneumatic jack.

In Example 74, the subject matter of any one of Examples 70 to 73 may include, wherein the sensor data comprises data from a global positioning system receiver.

In Example 75, the subject matter of any one of Examples 70 to 74 may include, wherein the sensor data comprises data from a short-range telemetry circuit.

In Example 76, the subject matter of any one of Examples 70 to 75 may include, wherein the short-range telemetry circuit comprises an RFID location system.

In Example 77, the subject matter of any one of Examples 70 to 76 may include, wherein the short-range telemetry circuit comprises a Bluetooth location system.

In Example 78, the subject matter of any one of Examples 70 to 77 may include, wherein the sensor data comprises data from a motion sensor.

In Example 79, the subject matter of any one of Examples 70 to 78 may include, wherein the motion sensor comprises an accelerometer.

In Example 80, the subject matter of any one of Examples 70 to 79 may include, wherein the motion sensor comprises a gyroscope.

In Example 81, the subject matter of any one of Examples 70 to 80 may include, wherein the means for determining the state of the smart jack apparatus based on sensor data comprise means for detecting a movement of the smart jack apparatus in the vertical or horizontal plane, and wherein the means for presenting the indication of the state of the smart jack apparatus to the user comprise means for sounding an alarm.

In Example 82, the subject matter of any one of Examples 70 to 81 may include, wherein the means for sounding the alarm comprise means for producing the alarm at the smart jack apparatus.

In Example 83, the subject matter of any one of Examples 70 to 82 may include, wherein the means for sounding the alarm comprise means for causing the alarm to be sounded from an object being lifted by the smart jack apparatus.

In Example 84, the subject matter of any one of Examples 70 to 83 may include, wherein the means for presenting the indication of the state of the smart jack apparatus to the user comprise: means for presenting an alignment user interface to indicate a position of the smart jack apparatus with respect to an object the smart jack apparatus is to lift.

In Example 85, the subject matter of any one of Examples 70 to 84 may include, wherein the object comprises a vehicle.

In Example 86, the subject matter of any one of Examples 70 to 85 may include, wherein the alignment user interface comprises a crosshair configuration of light-emitting diodes.

In Example 87, the subject matter of any one of Examples 70 to 86 may include, wherein the alignment user interface comprises a level indicator in at least one of: the horizontal plane or the vertical plane.

In Example 88, the subject matter of any one of Examples 70 to 87 may include, wherein the alignment user interface comprises a representation of the object the smart jack apparatus is to lift and a representation of the smart jack apparatus with respect to the representation of the object.

In Example 89, the subject matter of any one of Examples 70 to 88 may include, wherein the object comprises a vehicle.

In Example 90, the subject matter of any one of Examples 70 to 89 may include, wherein the means for presenting the indication of the state of the smart jack apparatus to the user comprise: means for transmitting information to an in-vehicle infotainment system for displaying the indication of the state of the smart jack apparatus.

In Example 91, the subject matter of any one of Examples 70 to 90 may include, wherein the means for presenting the indication of the state of the smart jack apparatus to the user comprise: means for transmitting information to a user device for displaying the indication of the state of the smart jack apparatus.

In Example 92, the subject matter of any one of Examples 70 to 91 may include, wherein the indication of the state comprises at least one of: a load indication, an alignment indication, or a positioning indication.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A smart jack device, the smart jack device comprising:
a lifting mechanism;
at least one of: a position sensor or a motion sensor;
a processor subsystem; and
a memory including instructions, which when executed by the processor subsystem, cause the processor subsystem to:
access sensor data from at least one of: the position sensor or the motion sensor, the sensor data indicative of a state of the smart jack device; and
cause the presentation of an indication of the state of the smart jack device,
wherein the state of the smart jack device comprises a movement in the vertical or horizontal plane indicating that the smart jack is losing stability or failing after having been placed in a jack position, and wherein instructions to cause the presentation of the indication of the state of the smart jack device, comprise instructions to sound an alarm.

2. The device of claim 1, wherein the position sensor comprises a short-range telemetry circuit.

3. The device of claim 2, wherein the short-range telemetry circuit comprises a Bluetooth location system.

4. (canceled)

5. A smart jack device, the smart jack device comprising:
a lifting mechanism;
at least one of: a position sensor or a motion sensor;
a sensor control module to access sensor data from at least one of: the position sensor or the motion sensor, the sensor data indicative of a state of the smart jack device; and
a presentation module to cause the presentation of an indication of the state of the smart jack device,
wherein the state of the smart jack device comprises a movement in the vertical or horizontal plane indicating that the smart jack is losing stability or failing after having been placed in a jack position, and wherein the presentation module is to sound an alarm.

6. The device of claim 5, wherein the position sensor comprises a short-range telemetry circuit.

7. The device of claim 5, wherein the motion sensor comprises an accelerometer.

8. The device of claim 5, wherein the motion sensor comprises a gyroscope.

9. (canceled)

10. The device of claim 5, wherein the alarm is produced at an object being lifted by the smart jack device.

11. The device of claim 5, wherein the presentation module is to:
present an alignment user interface on a display to indicate a position of the smart jack device with respect to an object the smart jack device is to lift.

12. The device of claim 11, wherein the alignment user interface comprises a representation of the object the smart jack device is to lift and a representation of the smart jack device with respect to the representation of the object.

13. The device of claim 5, wherein the presentation module is to:
transmit information to an in-vehicle infotainment system for displaying the indication of the state of the smart jack device.

14. The device of claim 5, wherein the presentation module is to:
transmit information to a user device for displaying the indication of the state of the smart jack device.

15. A method of using a smart jack, the method comprising:
determining, by the smart jack, a state of the smart jack based on sensor data, the state of the smart jack including a movement of the smart jack in the vertical or horizontal plane indicating that the smart jack is losing stability or failing after having been placed in a jack position; and
presenting an indication of the state of the smart jack to a user, including sounding an alarm.

16. (canceled)

17. The method of claim 15, wherein presenting the indication of the state of the smart jack to the user comprises:
presenting an alignment user interface to indicate a position of the smart jack with respect to an object the smart jack is to lift.

18. The method of claim 17, wherein the alignment user interface comprises a crosshair configuration of light-emitting diodes.

19. The method of claim 17, wherein the alignment user interface comprises a level indicator in at least one of: the horizontal plane or the vertical plane.

20. The method of claim 17, wherein the alignment user interface comprises a representation of the object the smart jack is to lift and a representation of the smart jack with respect to the representation of the object.

21. The method of claim 15, wherein presenting the indication of the state of the smart jack to the user comprises:
transmitting information to an in-vehicle infotainment system for displaying the indication of the state of the smart jack.

22. At least one non-transitory machine-readable medium including instructions, which when executed by a smart jack, cause the smart jack to perform operations comprising:
determining, by the smart jack, a state of the smart jack based on sensor data, the state of the smart jack including a movement of the smart jack in the vertical or horizontal plane indicating that the smart jack is losing stability or failing after having been placed in a jack position; and
presenting an indication of the state of the smart jack to a user, including sounding an alarm.

23. The at least one non-transitory machine-readable medium of claim 22, wherein determining the state of the smart jack based on sensor data comprises detecting a movement of the smart jack in the vertical or horizontal plane, and wherein presenting the indication of the state of the smart jack to the user comprises sounding an alarm.

24. The at least one non-transitory machine-readable medium of claim 22, wherein presenting the indication of the state of the smart jack to the user comprises:
transmitting information to an in-vehicle infotainment system for displaying the indication of the state of the smart jack.

25. The at least one non-transitory machine-readable medium of claim 22, wherein presenting the indication of the state of the smart jack to the user comprises:
transmitting information to a user device for displaying the indication of the state of the smart jack.
